(19) United States
(12) Patent Application Publication
(10) Pub. No.: US 2024/0401975 A1
(43) Pub. Date: Dec. 5, 2024

(54) SENSOR FUSION FOR VISUAL-INERTIAL ODOMETRY IN AUTONOMOUS SYSTEMS AND APPLICATIONS

(71) Applicant: NVIDIA Corporation, Santa Clara, CA (US)

(72) Inventors: Alexander Korovko, Redmond, WA (US); Aigul Dzhumamuralova, Yerevan (AM)

(21) Appl. No.: 18/326,730

(22) Filed: May 31, 2023

(51) Int. Cl. G01C 21/00; B60W 60/00; G06V 20/56

(52) U.S. Cl. CPC G01C 21/3896; B60W 60/001; G06V 20/56; B60W 2420/403

(57) ABSTRACT

In various examples, sensor fusion for visual-inertial odometry in autonomous and semi-autonomous systems and applications is described herein. Systems and methods are disclosed that split processing into at least two components. For example, the first component may be configured to process incoming frames, execute one or more perspective-n-point techniques to determine states of a machine, update states associated with one or more inertial measurement unit sensors of the machine, and add new frames to a map. The second component may be configured to adjust states (e.g., poses) associated with the machine using one or more sparse bundle adjustment techniques, adjust points within an environment, and adjust IMU-related parameters using a history of camera states. In some examples, the PnP technique and/or the SBA technique may be selected based on states associated with the IMU sensor(s).

### BACKGROUND

Determining the position and orientation of a machine, such as a vehicle (e.g., an autonomous vehicle, a semi-autonomous vehicle, etc.), a robot, or other type of machine, is important in order to accurately and precisely navigate the machine through an environment. As such, the vehicle may use various techniques, such as visual odometry, to determine the position and orientation of the machine. For example, to use visual odometry, the machine may generate image data using one or more cameras located on the machine, where the image data represents multiple frames. The machine may then process the image data in order to determine locations of features depicted by the frames and use the locations of the features to determine the position and orientation of the machine. In some examples, such as to improve the accuracy of the visual odometry, the machine may further use additional sensor data, such as motion data generated using one or more inertial measurement unit (IMU) sensors of the machine, to determine the location and orientation of the machine.

However, problems may occur when using conventional techniques of visual odometry and/or inertial visual odometry to determine the locations and orientations of the machine. For example, the conventional techniques may be unable to provide accurate or precise results under certain circumstances, such as when the frames do not depict easily identifiable features (e.g., the surfaces depicted by the frames do not have texture), there is high motion blur, and/or the camera(s) is obscured by dynamic objects. Additionally, even though the conventional techniques may use both visual measurements and IMU measurements to determine the locations and orientations of the machine, the conventional techniques may not fuse the visual measurements with the IMU measurements in such a way that increases the accuracy of the results.

### SUMMARY

Embodiments of the present disclosure relate to sensor fusion for visual-inertial odometry in autonomous or semi-autonomous systems and applications. Systems and methods are disclosed that split processing into at least two components (e.g., two threads). For example, the first component may be configured to process incoming frames (e.g., images represented by image data), execute one or more perspective-n-point (PnP) techniques to determine states of a machine, update states associated with one or more inertial measurement unit (IMU) sensors of the machine, and add new frames (e.g., keyframes) to a map. The second component may be configured to adjust states (e.g., poses) associated with the machine using one or more sparse bundle adjustment (SBA) techniques, adjust points within an environment, and adjust IMU-related parameters using a history of camera states. In some examples, the PnP technique used by the first component and/or the SBA technique used by the second component may be selected based on one or more factors, such as the states associated with the IMU sensor(s).

In contrast to conventional systems, such as those described above that perform the conventional techniques for visual odometry, the current systems, in some examples, are able to better fuse the image data and the motion data in order to provide more accurate results for the states of the machine. For instance, and as described in more detail herein, the current systems are able to perform such fusion based on using the states associated with the IMU sensor(s) as well as improved techniques for both PnP and SBA. Additionally, by performing such fusion between the image data and the motion data, the current systems, in some embodiments, are able to provide these more accurate, precise, and reliable results even when circumstances occur that make it difficult to determines the states of the machine, such as when the images do not depict easily identifiable features (e.g., the surfaces depicted by the frames do not have texture), there is high motion blur, and/or the image sensor(s) is obscured by dynamic objects.

### BRIEF DESCRIPTION OF THE DRAWINGS

The present systems and methods for sensor fusion for visual-inertial odometry in autonomous or semi-autonomous systems and applications are described in detail below with reference to the attached drawing figures, wherein:

FIG. 1 illustrates an example data flow diagram for a process of determining state information using sensor fusion, in accordance with some embodiments of the present disclosure;

FIG. 2 illustrates an example of determining a perspective-n-point (PnP) technique based at least on a state associated with one or more motion sensors, in accordance with some embodiments of the present disclosure;

FIG. 3 illustrates an example of determining a current state associated with a machine using soft inertial PnP, in accordance with some embodiments of the present disclosure;

FIG. 4 illustrates an example of a process that may be performed by a PnP thread to determine state information using sensor fusion, in accordance with some embodiments of the present disclosure;

FIG. 5 illustrates an example of using inertial sparse bundle adjustment (SBA) to determine states associated with a machine, in accordance with some embodiments of the present disclosure;

FIG. 6 illustrates an example of a process that may be performed by a SBA thread to determine state information using sensor fusion, in accordance with some embodiments of the present disclosure;

FIG. 7 illustrates an example of determining gravity vector directions, in accordance with some embodiments of the present disclosure.

FIG. 8 is a flow diagram showing a method for determining a state of a machine using different PnP techniques, in accordance with some embodiments of the present disclosure;

FIG. 9 is a flow diagram showing a method for determining a state of a machine using a PnP technique that optimizes multiple states associated with the machine, in accordance with some embodiments of the present disclosure

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

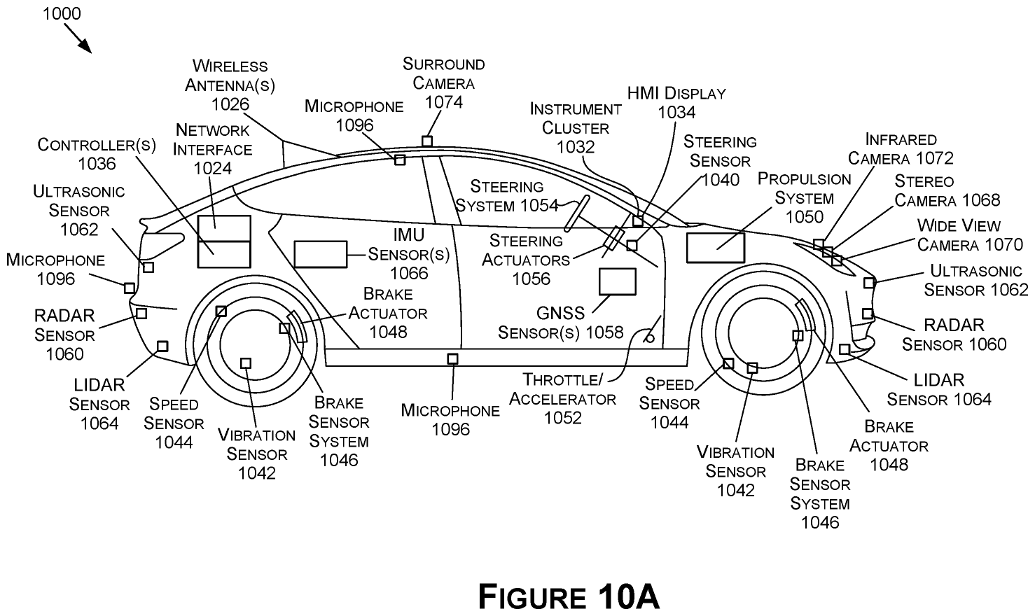

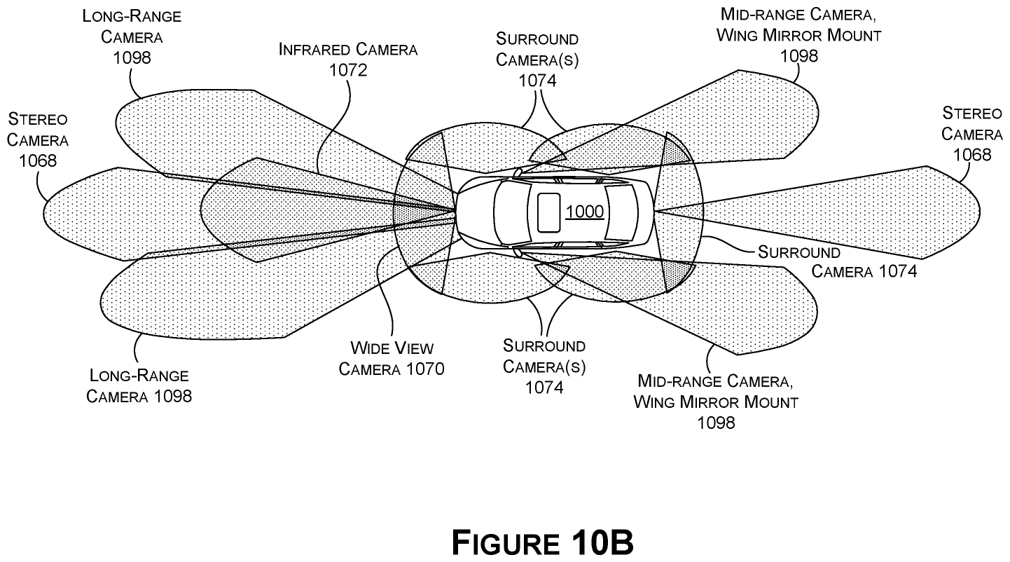

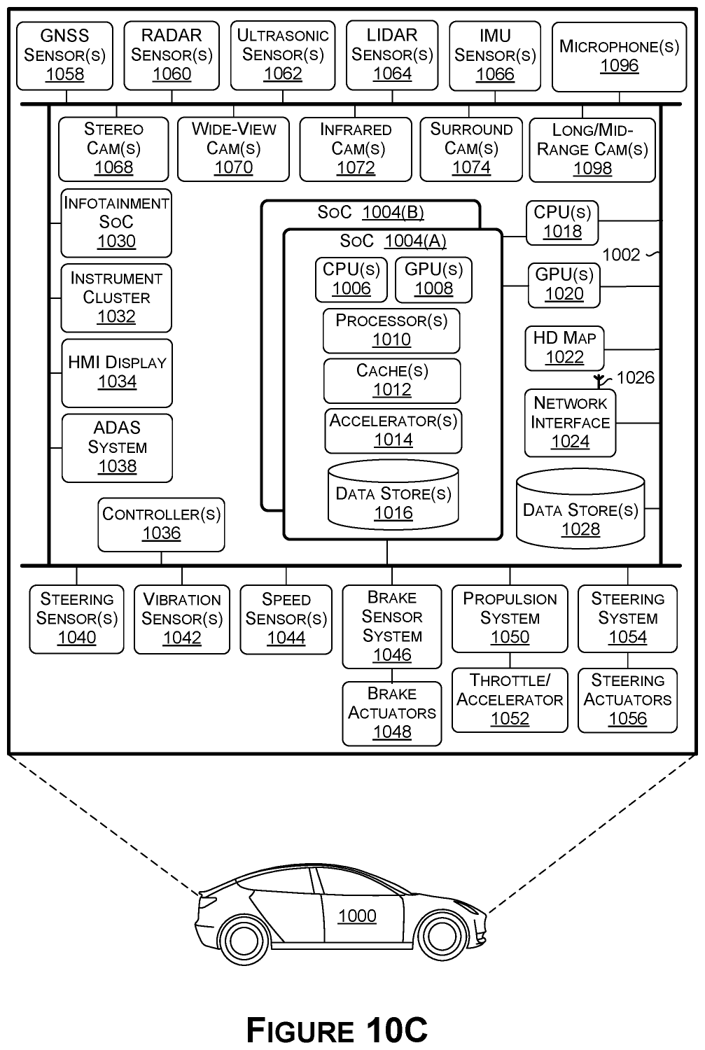

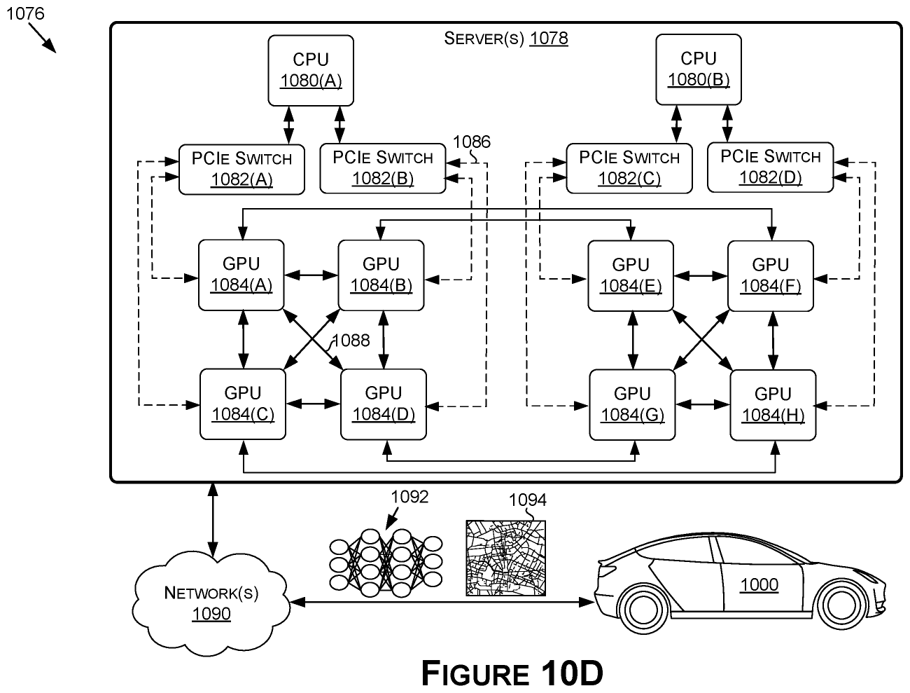

Systems and methods are disclosed related to sensor fusion for visual-inertial odometry in autonomous or semi-autonomous systems and applications. Although the present disclosure may be described with respect to an example autonomous vehicle 1000 (alternatively referred to herein as “vehicle 1000” or “ego-machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous systems and machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to visual-inertial odometry in robotics or other autonomous or semi-autonomous applications, this is not intended to be limiting, and the systems and methods described herein may be used in augmented reality, virtual reality, mixed reality, robotics, security and surveillance, autonomous or semi-autonomous machine applications, and/or any other technology spaces where visual-inertial odometry may be used.

For instance, a system(s) may receive sensor data generated using one or more sensors of a machine. As described herein, the sensor data may include, but is not limited to, image data generated using one or more image sensors, sensor data generation using one or more other sensor modalities (LiDAR, RADAR, ultrasonic, etc.), motion data generated using one or more inertial measurement unit (IMU) sensors (e.g., accelerometer, gyroscope, magnetometer, etc.), and/or any other type of sensor data generated using any other type of sensor. In some examples, such as when the sensor data is generated using the image sensor(s) and the IMU sensor(s), the image sensor(s) may be synchronized and/or calibrated with the IMU sensor(s). For instance, at least a portion of the image data generated using the image sensor(s) may be time synchronized with at least a portion of the motion data generated using the IMU sensor(s). As described herein, the synchronization may allow for better fusion between the image data and the motion data. In some embodiments, the synchronization may be performed using one or more intrinsic and/or one or more extrinsic parameters of the image sensors (or other sensor modalities) and the IMU sensors. Clock synchronization may be performed using any suitable clock or time synchronization techniques.

That system(s) may include and/or use an architecture to process (e.g., fuse) the sensor data. For example, the architecture may include at least a first component (e.g., a first thread, which may also be referred to as a “perspective-n-point (PnP) thread”) that performs first processing on at least a portion of the sensor data in order to generate one or more first outputs and a second component (e.g., a second thread, which may also be referred to as a “sparse bundle adjustment (SBA) thread”) that performs second processing on at least a portion of the sensor data in order to generate one or more second outputs. In some examples, the first component performs the first processing at least partially concurrently with the second processing performed by the second component. In some examples, the first component and the second component may communicate data between one another while performing the processing.

For instance, the first component may be configured to manage frames (e.g., images) represented by the image data, execute one or more PnP techniques to determine states of the machine (e.g., states of the image sensor(s), such as a camera state vector), update states associated with the IMU sensor(s) of the machine, and add new frames (e.g., keyframes) to a map. To perform the processing, and based on receiving a frame represented by the image data, the first component may retrieve (e.g., pull) a new map from the second component. The first component may then perform one or more of the processes described herein to determine a state associated with the IMU sensor(s) (which may also be referred to as a “machine state”). In some examples, the states associated with the IMU sensor(s) may include, but are not limited to, an uninitialized state, an invalid state, and a valid state. For instance, the IMU sensor(s) may initially be in the uninitialized state before any processing is performed (e.g., this is the first frame to process). The IMU sensor(s) may then be in the invalid state when there are a number of failures (a number of failures that is equal to or greater than a threshold number of failures) associated with the processing, which is described in more detail herein. Additionally, the IMU sensor(s) may be in the valid state when there are few or no failures (e.g., a number of failures that is less than the threshold number of failures) associated with the processing.

If it is determined that the IMU sensor(s) is in a first state, which may correspond to the uninitialized state and/or the invalid state, then the first component may use a first PnP technique to process the sensor data. The first PnP technique, which may also be referred to as “regular PnP,” may use visual constraints, inertial constraints, and/or random walk constraints between frames to predict a new state of the machine. Additionally, the first PnP technique may use a fixed previous state associated with the machine (e.g., a fixed state associated with the image sensor(s)) along with the image data and the motion data, to predict the new state associated with the machine. However, if it is determined that the IMU sensor(s) is in a second state, which may correspond to the valid state, then the first component may use a second PnP technique to process the sensor data. The second PnP technique, which may also be referred to as “soft inertial PnP,” may again use visual constraints, inertial constraints, and/or random walk constraints between frames to predict a new state of the machine. However, instead of fixing the previous state, the second PnP technique may represent the previous state using a random variable when predicting the new state associated with the machine. The second PnP may perform such processes based on the stochastic nature of the measurements, such that the there is a level of uncertainty when determining the states associated with the machine.

In some examples, the first component may then determine whether the prediction of the new state has failed, which is described in more detail herein, and perform one or more processes based on this determination. For a first example, and if the first component uses the first PnP technique, the first component may determine that tracking is lost based on the prediction of the new state failing and/or return the predicted new state based on the prediction of the new state not failing. For a second example, and if the first component uses the second PnP technique, the first component may determine that tracking is lost based on the predictions of the new states failing a threshold number of times in a row and/or return the predicted new state based on the predictions of the new states not failing the threshold number of times in a row.

Additionally, in some examples, the first component may perform one or more additional processes. For a first example, the first component may determine a new state associated with the IMU sensor(s), which is described in more detail herein, and then update the state associated with the IMU sensor(s) to the new state. This new state may then be used for processing the next frame represented by the image data. For a second example, the first component may add at least a portion of the information associated with the new state (e.g., the pose of the machine) and/or the frame to the map. In some examples, the first component adds the frame based on the frame including a keyframe, where a keyframe may include a frame that the first component uses to determine new features for the PnP techniques. While these are just a couple examples of additional processes that may be performed by the first component, in other examples, the first component may perform additional and/or alternative processes.

The second component may be configured to adjust states (e.g., poses) associated with the machine using one or more SBA techniques, adjust points within an environment, and adjust IMU-related parameters using a history of camera states. For instance, the second component may initially wait for and then retrieve (e.g., pull) updates to the map from the first component. The second component may then perform one or more of the processes described herein to determine the state associated with the IMU sensor(s). If it is determined that the IMU sensor(s) is in the first state, which may again correspond to the uninitialized state and/or the invalid state, then the second component may use a first SBA technique to process the sensor data. The first SBA technique, which may also be referred to as “regular SBA,” may use one or more previous states associated with the machine, along with the image data, to determine a new state associated with the machine. Additionally, if it is determined that the IMU sensor(s) is in the second state, which may again correspond to the valid state, then the second component may use a second SBA technique to process the sensor data. The second SBA technique, which may also be referred to as “inertial SBA,” may use one or more previous states associated with the machine, along with the image data and the motion data, to determine the new state associated with the machine.

In some examples, the first SBA technique and/or the second SBA technique may use one or more constraints when determining the new state associated with the machine. For example, the second SBA technique may use camera constraints, inertial constraints, and/or random walk constraints when determining the new state associated with the machine. Additionally, such as to improve the convergence of the SBA, the second SBA technique may fix a threshold number of the oldest previous states that are used to determine the new state associated with the machine. The threshold number may include, but is not limited to, the oldest two of five previous states, the oldest three of ten previous states, and/or the like. Furthermore, in some examples, the second component may only use keyframes when performing the first SBA technique and/or the second SBA technique.

The second component may further be configured to update the map based at least on the newly predicted states associated with the machine. Additionally, the second component may be configured to notify the first component when the map is updated. This way, the first component may retrieve the map when processing new frames represented by the image data. While these are just a couple examples of processes that may be performed by the second component, in other examples, the second component may perform additional and/or alternative processes.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implementing one or more large language models (LLMs), systems implemented at least partially in a data center, systems for performing conversational AI operations, systems for performing light transport simulation, systems for performing collaborative content creation for 3D assets, systems implemented at least partially using cloud computing resources, and/or other types of systems.

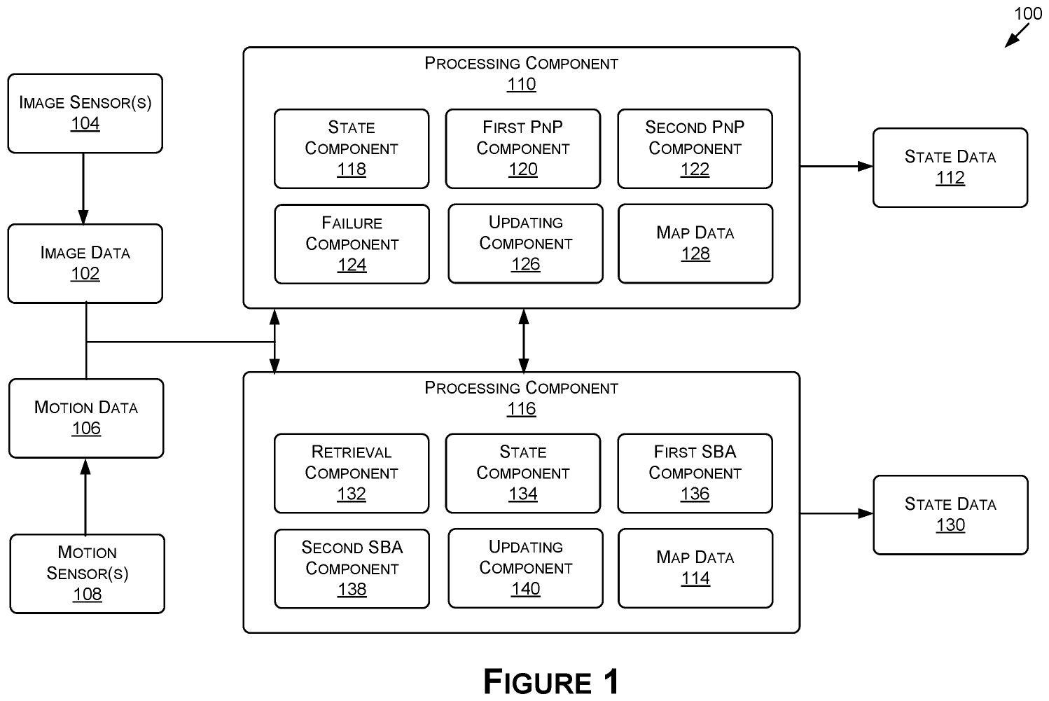

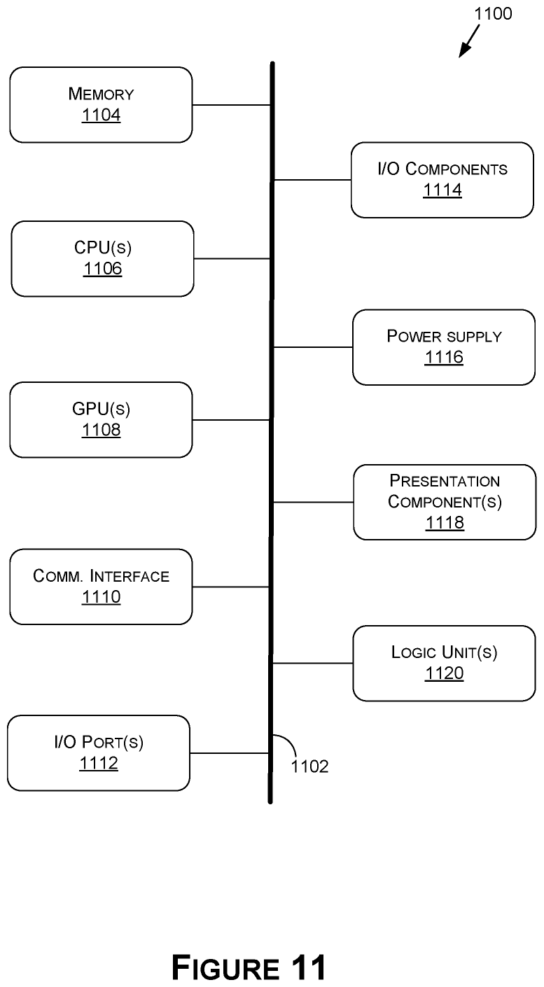

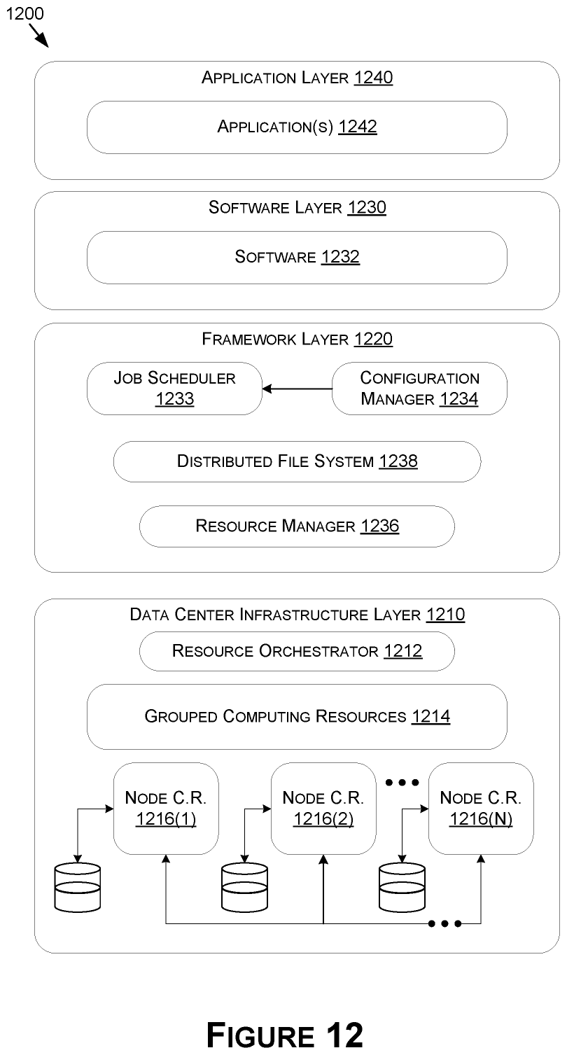

With reference to FIG. 1, FIG. 1 illustrates an example data flow diagram for a process 100 of determining state information using sensor fusion, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous or semi-autonomous vehicle or machine 1000 of FIGS. 10A-10D, example computing device 1100 of FIG. 11, and/or example data center 1200 of FIG. 12.

The process may include receiving image data 102 generated using one or more image sensors 104 and receiving motion data 106 generated using one or more motion sensors 108 of a machine. For instance, the image sensor(s) 104 and/or the motion sensor(s) 108 may be associated with (e.g., disposed on or located on) a machine that is navigating around an environment. As described herein, the image data 102 may represent one or more frames (e.g., one or more images) depicting an environment for which the machine is navigating. Additionally, the motion data 106 may represent the motion of the machine within the environment when generating the image data 102. For example, the motion sensor(s) may include one or more IMU sensors, where an IMU sensor includes one or more accelerometers, one or more gyroscopes, one or more magnetometers, and/or so forth that measure the velocity, the acceleration, the angular rate, the orientation, and/or the like associated with the machine.

In some examples, at least a portion of the image data 102 may be synchronized with at least a portion of the motion data. For example, the frames represented by the image data 102 may be associated with first timestamps while various portions of the motion data 106 may be associated with second timestamps, where the first timestamps and the second timestamps may be used to synchronize the frames with the portions of the motion data. Additionally, in some examples, the image sensor(s) 104 may be calibrated with respect to the motion sensor(s) 108.

The process 100 may include processing the image data 102 and/or the motion data 106 using a first processing component 110 that is configured to at least determine states associated with the machine, where the states are represented by state data 112. As described herein, in some examples, the first processing component 110 may correspond to a first thread, such as a PnP thread, executed by one or more processors. Additionally, the first processing component 110 may be configured to at least manage frames (e.g., images) represented by the image data 102, execute one or more PnP techniques to determine states of the machine, update states associated with motion sensor(s) 108 of the machine, and add new fames (e.g., keyframes) to a map.

For instance, based on receiving image data 102 representing a new frame, the first processing component 110 may be configured to retrieve map data 114 from a second processing component 116, where the map data 114 represents a map updated by the second processing component 116 (which is described in more detail herein). The first processing component 110 may then use a state component 118 to determine a current state associated with the motion sensor(s) 108 (e.g., determine the current “state machine”). As described herein, the states associated with the motion sensor(s) 108 may include, but are not limited to, an uninitialized state, an invalid state, or a valid state. For instance, the motion sensor(s) 108 may initially be in the uninitialized state before any processing is performed (e.g., this is the first frame to process). The motion sensor(s) 108 may then be in the invalid state when there are a number of failures (a number of failures that is equal to or greater than a threshold number of failures) associated with the processing, which is described in more detail herein. Additionally, the motion sensor(s) 108 may be in the valid state when there are little or no failures (e.g., a number of failures that is less than the threshold number of failures) associated with the processing. The first processing component 110 may then determine a mode for operating to determine a state vector (e.g., a state of the machine and/or a state of the image sensor(s) 104) based on the state machine, such as whether to use a first PnP component 120 or a second PnP component 122 based at least on the state of the motion sensor(s) 108.

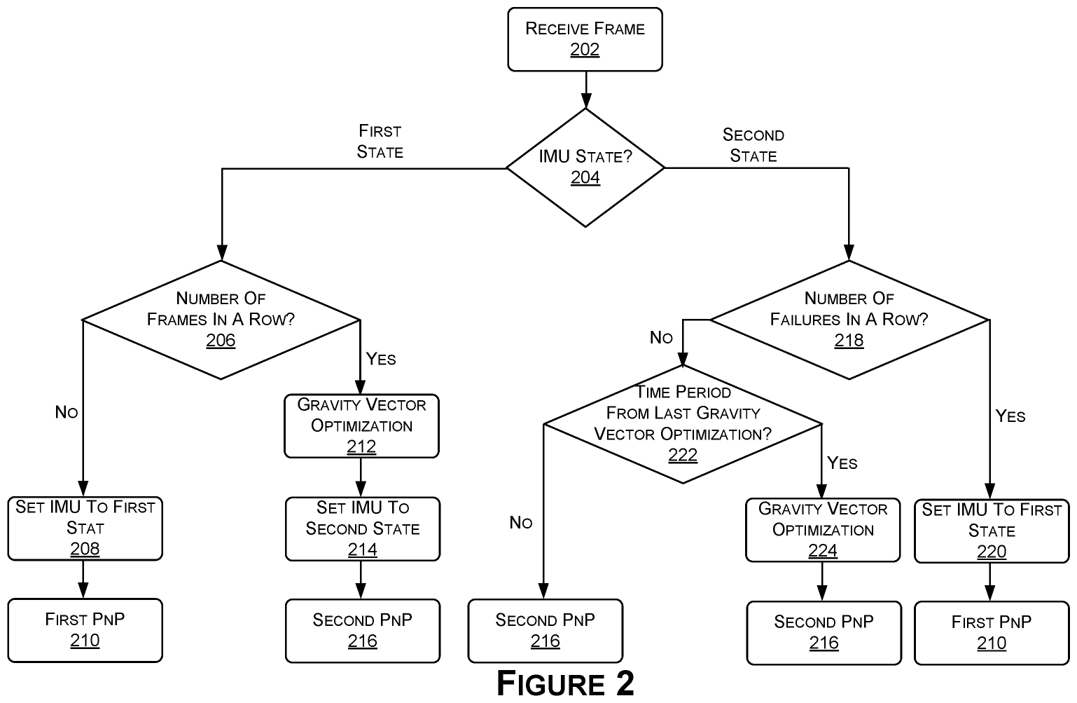

For instance, FIG. 2 illustrates an example of determining a PnP technique based at least on a state associated with the motion sensor(s) 108, in accordance with some embodiments of the present disclosure. In some examples, FIG. 2 may be used to determine a “state machine” associated with the machine, where the state machine indicates the mode for which the machine should operate. For example, the state machine may indicate whether the machine should operate in a first mode for which the machine uses a first PnP technique and/or a first SBA technique to determine a state vector or a second mode for which the machine uses a second PnP technique and/or a second SBA technique to determine the state vector. As described herein, the state vector may indicate the state of the image sensor(s) 104 and/or the machine.

As shown, based on the first processing component 110 receiving a new frame 202 (which may be represented by the image data 102), the state component 118 may determine an IMU state 204 (e.g., the state of the motion sensor(s) 108). If the state component 118 determines that the IMU state 204 includes a first state, such as the uninitialized state or the invalid state, then the state component 118 may determine whether a number of successful PnP determinations in a row have exceeded a threshold number. In some examples, the threshold number may include, but is not limited to, one, two, five, ten, and/or any other number.

If the state component 118 determines that the number of successful PnP determinations in a row has not exceed the threshold 206, then the state component 118 may set a new state associated with the IMU sensor(s) to the first state at 208. Additionally, the first processing component 110 may determine to use a first PnP technique 210 (e.g., use the first PnP component 120) to determine the new state of the machine. However, if the state component 118 determines that the number of successful PnP determinations has reached the threshold 206, then the state component 118 may cause a gravity vector optimization process 212 to be performed, which is described in more detail herein. Additionally, the state component 118 may set a new state associated with the IMU sensor(s) to the second state at 214 and the first processing component 110 may determine to use a second PnP technique 216 (e.g., the second PnP component 122) to determine the new state of the machine.

However, if the state component 118 determines that the IMU state 204 includes a second state, such as the valid state, then the state component 118 may determine whether a number of failed PnPs in a row has exceeded a threshold 218, which is described in more detail herein. The number of failures may include, but is not limited to, one failure, five failures, ten failures, and/or any other number of failures. If the state component 118 determines that the number of failures has been reached, then the state component 118 may set a new state associated with the IMU sensor(s) to the first state at 220. Additionally, the first processing component 110 may determine to use the first PnP technique 210 (e.g., use the first PnP component 120) to determine the new state of the machine.

However, if the state component 118 determines that the number of failures has not been reached, then the state component 118 may determine whether a time period from a last gravity vector optimization has elapsed at 222. As described herein, the time period may include, but is not limited to, one second, two seconds, five seconds, and/or any other time period. If the state component 118 determines that the time period has not elapsed, then the first processing component 110 may determine to use the second PnP technique 216 (e.g., the second PnP component 122) to determine the new state of the machine. However, if the state component 118 determines that the time period has elapsed, then the state component 118 may cause a gravity vector optimization process 224 to be performed. Additionally, the first processing component 110 may again determine to use the second PnP technique 216 (e.g., the second PnP component 122) to determine the new state of the machine.

Referring back to the example of FIG. 1, the process 100 may include the first processing component 110 using the first PnP component 120 or the second PnP component 122 to determine the new state of the machine, such as based on the determined state of the motion sensor(s) 108. As described herein, the first PnP component 120 may use a first PnP technique, which may also be referred to as “regular PnP.” For instance, the first PnP technique may use the image data 102 without the motion data 106 to predict a new state of the machine. For example, the first PnP technique may use visual constraints, inertial constraints, and/or random walk constraints between frames to predict the new state of the machine. Additionally, the first PnP technique may use a fixed previous state associated with the machine (e.g., a fixed state associated with the image sensor(s) 104), along with the image data 102 and the motion data 106, to predict the new state associated with the machine.

The second PnP component 122 may use a second PnP technique, which may also be referred to as “soft inertial PnP.” Similar to the first PnP technique used by the first PnP component 120, the second PnP technique may use visual constraints, inertial constraints, and random walk constraints between frames to predict a new state of the machine. However, unlike the first PnP technique, the second PnP technique may treat the previous state of the machine as a random variable, such as by using a gaussian distribution, which includes a mean of covariance describing the uncertainty of the previous state. In some examples, the second PnP technique may perform such processes based on the stochastic nature of the measurements such that the state of the machine may include some level of uncertainty. For instance, the second PnP technique may be determined using the following equations:

$$\\ \begin{matrix}{s}_{1}^{{}_{} opt} , {s}_{2}^{{}_{} opt} = arg {min}_{{s}_{1} , {s}_{2}} ( {L}_{visual} ( {S}_{2} ) + {L}_{inertial} ( {S}_{1} , {S}_{2} ) + {L}_{RW} ( {S}_{1} , {S}_{2} ) + {L}_{prior} ( {S}_{2} ) ) & ( 1 )\end{matrix}$$

$$\\ \begin{matrix}{e}_{visual} {T}_{2} = {\sum }_{i ∈ L} {uv}_{i} - π ( {T}_{2}^{{}_{} - 1} {p}_{i} ) & ( 2 )\end{matrix}$$

$$\\ \begin{matrix}{L}_{visual} {T}_{2} = {e}_{visual}^{{}_{} T} {\sum }_{visual}^{- 1} {e}_{visual} & ( 3 )\end{matrix}$$

$$\\ \begin{matrix}{L}_{inertial} ( {T}_{1} , {T}_{2} ) = {e}_{I}^{{}_{} t} {\sum }^{- 1} {e}_{I} & ( 4 )\end{matrix}$$

$$\\ \begin{matrix}{L}_{RW} ( {T}_{1} , {T}_{2} ) = {e}_{RW}^{{}_{} t} {\sum }^{- 1} {e}_{RW} & ( 5 )\end{matrix}$$

$$\\ \begin{matrix}{L}_{prior} ( {S}_{1} ) = {e}_{prior}^{{}_{} T} {\sum }_{prior}^{- 1} {e}_{prior} & ( 6 )\end{matrix}$$

$$\\ \begin{matrix}{e}_{I} = ( \begin{matrix}log ( Δ {R}^{{}_{} T} {R}_{1}^{{}_{} T} {R}_{2} ) \\ {R}_{1}^{{}_{} T} ( {v}_{2} - {v}_{1} - g Δ t ) - Δ v \\ {R}_{1}^{{}_{} T} ( {p}_{2} - {p}_{1} - {v}_{1} Δ t - g \frac{Δ {t}^{{}_{} 2}}{2} ) - Δ p\end{matrix} ) & ( 7 )\end{matrix}$$

$$\\ \begin{matrix}{e}_{RW} = ( \begin{matrix}{Bias}_{2}^{{}_{} acc} - {Bias}_{1}^{{}_{} acc} \\ {Bias}_{2}^{{}_{} gyro} - {Bias}_{1}^{{}_{} gyro}\end{matrix} ) & ( 8 )\end{matrix}$$

$$\\ \begin{matrix}{e}_{prior} = ( \begin{matrix}log ( {R}_{1}^{{}_{} T} {R}_{prior} \\ {R}_{1}^{{}_{} T} ( {t}_{1} - {t}_{prior} ) \\ {v}_{1} - {v}_{prior} \\ {Bias}_{1}^{{}_{} acc} - {Bias}_{prior}^{{}_{} acc} \\ {Bias}_{1}^{{}_{} gyro} - {Bias}_{prior}^{{}_{} gyro}\end{matrix} ) & ( 9 )\end{matrix}$$

In equations (1)-(9), Σₚᵣᵢₒᵣ⁻¹ is an information matrix of the previous state of the machine which is predicted during a previous execution of equations (1)-(9). Additionally, equations (1)-(9) may be associated with a classic Gauss-Newton optimization procedure, which aims to iteratively minimize the loss function.

In some examples, an iteration (e.g., each iteration) of the equations (1)-(9) above solves a linear equation HΔx=b, where H is a Hessian matrix of a given size (e.g., 30×30) and has a meaning of information matrix for the joint gaussian distribution of two states (e.g., the previous state and the current state). As such, once the equation finishes, the value of H may be left. Because of this, the matrix corresponding to the current state may need to be extracted, where the current state matrix includes a given size (e.g., 15×15). As such, one or more techniques, such as a Schur Complement trick, may be used to extract the current state matrix.

For instance, variables of Δx may be split into two parts, Δxₐ and Δx_{b}, which may then be used to rewrite the equation as the following:

$$\\ \begin{matrix}[ \begin{matrix}U & W \\ {W}^{{}_{} T} & V\end{matrix} ] ( \begin{matrix}Δ {x}_{a} \\ Δ {x}_{b}\end{matrix} ) = [ \begin{matrix}{b}_{a} \\ {b}_{b}\end{matrix} ] & ( 10 )\end{matrix}$$

$$\\ \begin{matrix}H = [ \begin{matrix}U & W \\ {W}^{{}_{} T} & V\end{matrix} ] & ( 11 )\end{matrix}$$

$$\\ \begin{matrix}[ \begin{matrix}I & - {WV}^{{}_{} {}_{} - 1} \\ 0 & I\end{matrix} ] [ \begin{matrix}U & W \\ {W}^{{}_{} T} & V\end{matrix} ] ( \begin{matrix}Δ {x}_{a} \\ Δ {x}_{b}\end{matrix} ) = [ \begin{matrix}I & - {WV}^{{}_{} {}_{} - 1} \\ 0 & I\end{matrix} ] [ \begin{matrix}{b}_{a} \\ {b}_{b}\end{matrix} ] & ( 12 )\end{matrix}$$

$$\\ \begin{matrix}[ \begin{matrix}U - {WV}^{{}_{} {}_{} - 1} {W}^{{}_{} T} & 0 \\ {W}^{{}_{} T} & V\end{matrix} ] ( \begin{matrix}Δ {x}_{a} \\ Δ {x}_{b}\end{matrix} ) = [ \begin{matrix}{b}_{a} - {WV}^{{}_{} {}_{} - 1} {b}_{b} \\ {b}_{b}\end{matrix} ] & ( 13 )\end{matrix}$$

As shown, equation (12) is associated with multiplying both sides of equation (12) by a matrix of special form. Additionally, equation (13) indicates that the solution may be found by solving two separate linear equations consequently. The first line implies that the solution for Δxₐ may be found independently of any term in the second line. In some examples, that means that the matrix U−WV⁻¹ W^{T} corresponds to the matrix associated with the current state. While these are just a few equations that may be used to determine the current state of the machine, in other examples, additional and/or alternative equations may be used to determine the current state of the machine.

As described herein, the previous state and the current state may include a matrix of a given size, such as 15×15, representing the degrees of freedom associated with the states. As described herein, the degrees of freedom may include, but are not limited to, three degrees of rotation, three degrees of translation, three degrees of linear velocity, three degrees of gyroscope bias, three degrees of accelerometer bias, and/or any other degree of freedom. In some examples, the degrees of freedom may be represented using one or more matrices. For example, a first matrix may represent the rotational degrees of freedom, a second matrix may represent the translation degrees of freedom, a third matrix may represent the linear velocity degrees of freedom, a fourth matrix may represent the gyroscope bias degrees of freedom, and/or a fifth matrix may represent the accelerometer bias degrees of freedom. In such an example, if each matrix represents three degrees of freedom, then the combined state matrix may include the 15×15 matrix.

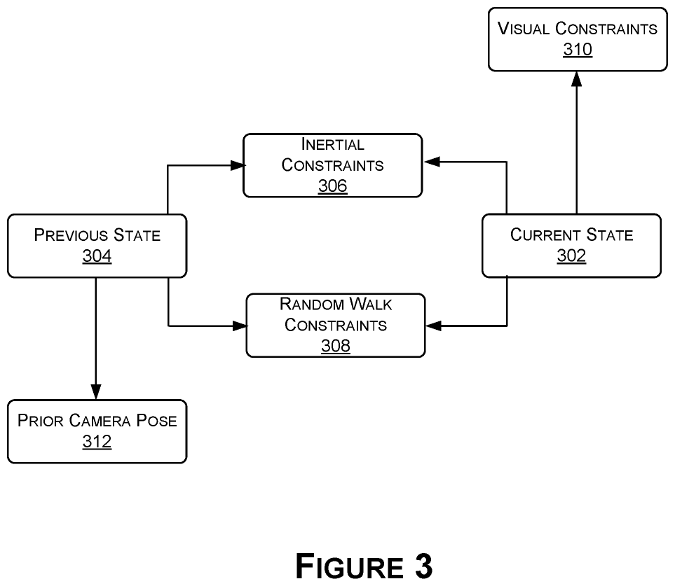

For instance, FIG. 3 illustrates an example of determining a current state 302 associated with the machine using soft inertial PnP, in accordance with some embodiments of the present disclosure. In the example of FIG. 3, both the current state 302 and a previous state 304 associated with the machine are treated as random variables (e.g., random variables associated with the fifteen degrees of freedom described herein). The current state 302 is then constrained by at least inertial constraints 306, random walk constraints 308, and visual constraints 310, which are represented by at least the equations (1)-(9) above. Additionally, the previous state 304 is constrained by the inertial constraints 306, the random walk constraints 308, and prior camera pose constraints 312, which are again represented by at least the equations (1)-(9) above. As such, in some examples, and in contrast to the first PnP technique described herein, the second PnP technique both varies the previous state 304 and uses the prior camera pose constraints 312.

Referring back to the example of FIG. 1, the first processing component 110 may include a failure component 124 that is configured to determine whether there is a failure associated with the processing performed by the first PnP component 120 and/or the processing performed by the second PnP component 122. In some examples, to determine whether the failure occurred with an iteration of the PnP determination, the failure component 124 may determine a total error associated with the determination. The total may be associated with the inertial constraints, the random walk constraints, the visual constraints, and/or any other constraints. The failure component 124 may then determine no failure occurred when the total error is less than a threshold error or determine that a failure did occur when the total error is equal to or greater than the error threshold.

As described herein, the state component 118 may then use the failure determinations from the failure component 124 when determining and/or updating the state associated with the motion sensor(s) 108 (which is described in detail with regard to the example of FIG. 2). For a first example, such as at process 218 from the example of FIG. 2, the state component 118 may determine the number of failures that have occurred in consecutive iterations of the PnP determinations. If the number of failures is less than a threshold number of failures (e.g., 1 failure, 5 failures, 10 failures, etc.), the state component 118 may determine that the motion sensor(s) 108 is in the second state, such as the valid state. However, if the number of failures is equal to or greater than the threshold number of failures, the state component 118 may determine that the motion sensor(s) 108 is in the first state, such as the invalid state.

For a second example, the state component 118 may determine a first number of failures that have occurred over a second number of iterations of the PnP determinations. The state component 118 may then determine whether the first number of failures is again equal to or greater than a threshold number of failures and/or a threshold percentage of failures (e.g., 10%, 25%, 50%, 75%, 90%, etc.). If the first number of failures is less than the threshold number of failures and/or the threshold percentage of failures, the state component 118 may determine that the motion sensor(s) 108 is in the second state, such as the valid state. However, if the first number of failures is equal to or greater than the threshold number of failures and/or the threshold percentage of failures, the state component 118 may determine that the motion sensor(s) 108 is in the first state, such as the invalid state.

The process 100 may include the first processing component 110 using an updating component 126 to update a map represented by map data 128. As described herein, the map may include at least a history of frames (e.g., keyframes), indications of two-dimensional (2D) observations of the frames, indications of three-dimensional (3D) landmarks within the environment, and/or any other information. As such, the updating component 126 may update the map with new frames, such as keyframes, that the first processing component 110 processes using the process 100 described herein. In some examples, the updating component 126 updates the map to include a threshold number of frames such as, but not limited to, 50 frames, 75 frames, 100 frames, 150 frames, 200 frames, and/or any other number of frames. Additionally, the updating component 126 may update the map to indicate the states associated with the machine, where the states are represented by the state data 112.

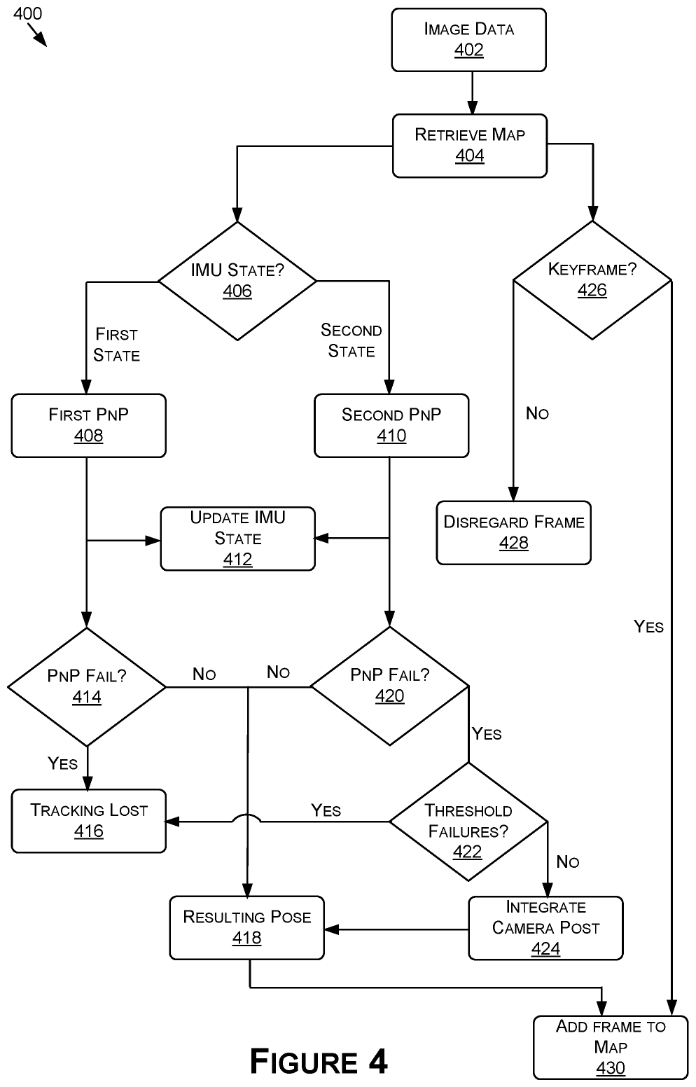

For an example of the processing performed by the first processing component 110, FIG. 4 illustrates an example of a process 400 that may be performed by a PnP thread for determining state information using sensor fusion, in accordance with some embodiments of the present disclosure. As shown, the process 400 may include receiving image data 402 (which may represent, and/or include, the image data 102) representing one or more frames. The process 400 may then include retrieving a map 404, such as the map represented by the map data 114. As described herein, in some examples, the map may be retrieved from the second processing component 116, such as the SBA thread. However, in other examples, such as when the second processing component 116 has yet to update the map, the retrieving of the map may include retrieving the most updated map generated by the first processing component 110 (e.g., the map represented by the map data 128).

The process 400 may then include determining an IMU state 406 associated with the IMU sensor(s) (e.g., the motion sensor(s) 108). As described herein, the IMU state may include a first state, such as an uninitialized state or an invalid state, or a second state, such as a valid state, associated with the IMU sensor(s). If it is determined that the IMU state includes the first state, then the process 400 may include processing the image data 402 and/or motion data using a first PnP technique. In some examples, the first PnP technique 408 may correspond to the processes described with respect to the first PnP component 120. However, if it is determined that the IMU state includes the second state, then the process 400 may include processing the image data 402 and/or the motion data using a second PnP technique 410. In some examples, the second PnP technique 410 may correspond to the processes described with respect to the second PnP component 122.

The process 400 may then include updating an IMU state 412 associated with the IMU sensor(s) based at least on the output from the first PNP technique 408 and/or the second PnP technique 410. For example, and as described herein, the IMU state 412 may be updated based on whether there is a failure with the determination of the state and/or whether there are one or more failures associated with multiple determinations of previous states.

If the first PnP technique 408 is used to determine the state, then the process 400 may include determining whether the PnP failed 414. If it is determined that the PnP failed 414, then the process 400 may include determining that tracking associated with the machine is lost 416. However, if it is determined that the PnP did not fail 414, then the process 400 may include outputting a resulting pose 418, such as a pose associated with the image sensor(s) used to generate the image data 402 and/or a pose associated with the machine that includes the image sensor(s).

Additionally, if the second PnP technique 410 is used to determine the state, then the process 400 may again include determining whether the PnP failed 422. However, in this scenario, if the PnP failed 420, then the process 400 may include making another determination of whether a threshold number of failures 422 has been reached. If the threshold number of failures 422 has been reached, then the process 400 may again include determining that the tracking is lost 416. However, if the threshold number of failures 422 has not been reached, then the process 400 may include integrating the camera pose 424 into the resulting pose 418. Additionally, if it is determined that the PnP did not fail 420, then the process 400 may again include outputting the resulting pose 418.

The process 400 may further include determining whether the frame represented by the image data 402 is a keyframe 426. In some examples, and as described herein, a keyframe includes a frame for which the machine (e.g., the PnP processing) determines initial points (e.g., feature points) within an environment for which the machine then processes subsequent frames to determine the states of the machine. If the frame is not the keyframe 426, then the process 400 may do nothing with the frame (e.g., ignore or disregard the frame). However, if the frame is the keyframe 426, then the process 400 may include adding the frame to the map 428. In some examples, the process 400 may further include adding other information to the map, such as the resulting pose 418.

Referring back to the example of FIG. 1, the process 100 may include processing the image data 102 and/or the motion data 106 using the second processing component 116 that is configured to at least determine states associated with the machine, where the states are represented by state data 130. As described herein, in some examples, the second processing component 116 may correspond to a second thread, such as a SBA thread, that is executed by the one or more processors. For instance, the second processing component 116 may be configured to adjust states (e.g., poses) associated with the machine using one or more SBA techniques, adjust points within an environment, adjust parameters associated with the motion sensor(s) 108 using a history of the states, and/or perform additional processing.

For instance, the process 100 may include the second processing component 116 using a retrieval component 132 to retrieve updates associated with the map that is represented by the map data 128. For example, and as described herein, the first processing component 110 may update the map based on new frames (e.g., new keyframes) and/or new states determined by the first processing component 110. As such, based at least on the first processing component 110 updating the map, the retrieval component 132 may retrieve (e.g., pull) the updates from the first processing component 110.

The process 100 may include the second processing component 116 using a state component 134 to determine a current state associated with the motion sensor(s) 108 (e.g., determine the current “state machine”). As described herein, the states associated with the motion sensor(s) 108 may include, but are not limited to, an uninitialized state, an invalid state, or a valid state. For instance, the motion sensor(s) 108 may initially be in the uninitialized state before any processing is performed (e.g., this is the first frame to process). The motion sensor(s) 108 may then be in the invalid state when there are a number of failures (a number of failures that is equal to or greater than a threshold number of failures) associated with the processing, which is described in more detail herein. Additionally, the motion sensor(s) 108 may be in the valid data when there are few or no failures (e.g., a number of failures that is less than the threshold number of failures) associated with the processing. In other words, the state component 134 may perform one or more similar processes as the state component 118.

The process 100 may include the second processing component 116 determining a mode for operating to determine a state vector (e.g., a state of the machine and/or a state of the image sensor(s) 104) based on the state machine, such as whether to use a first SBA component 136 or a second SBA component 138 based at least on the state of the motion sensor(s) 108. For instance, the second processing component 116 may determine to use the first SBA component 136 when the motion sensor(s) 108 is in the first state, such as the uninitialized state or the invalid state, and determine to use the second SBA component 138 when the motion sensor(s) 108 is in the second state, such as the valid state.

As described herein, the first SBA component 136 may use a first SBA technique, which may also be referred to as “regular SBA.” For instance, the first SBA component 136 may process the image data 102 and, based at least on the processing, refine 3D coordinates describing the environment for which the machine is navigating, refine the states of the motion associated with the machine, and/or refine the optical characteristics associated with the image sensor(s) 104. In some examples, the first SBA component 136 performs such processes by minimizing a reprojection error between frame locations of observed points and predicted frame points. For instance, the first SBA component 136 may perform the minimization using one or more nonlinear least-squares algorithms (e.g., the Levenberg-Marquardt algorithm, etc.).

For instance, the first SBA component 136 may assume that n 3D points are seen in m views, where xᵢⱼ is the projection of the ith point on frame j. Also let vᵢⱼ denote the binary variables that equal 1 if point i is visible in frame j and 0 otherwise. Furthermore, assume that each image sensor(s) 104 is parameterized by a vector aⱼ and each 3D point i by a vector bᵢ. The first SBA component 136 may then minimize the total reprojection error with respect to all 3D points and image sensor parameters, such as by using the following equation:

$$\\ \begin{matrix}{min}_{{a}_{j} , {b}_{j}} {}_{} {\sum }_{i = 1}^{n} {\sum }_{j = 1}^{m} {v}_{ij} {d ( Q ( {a}_{j} , {b}_{i} ) , {x}_{ij} )}^{2} & ( 14 )\end{matrix}$$

In equation (14), Q (aⱼ, bᵢ) is the predicted projection of point i on frame j and d(x, y) denotes the Euclidean distance between the frame points represented by vectors x and y. While this is just one example equation that may be used by the first SBA component 136 to determine the states associated with the machine, in other examples, the first SBA component 136 may use additional and/or alternative equations.

The second SBA component 138 may use a second SBA technique, which may be referred to as “inertial SBA.” For instance, the second SBA component 138 may use constraints, such as inertial constraints, random walk constraints, and/or video constraints between consecutive states associated with the machine. Additionally, such as to improve the convergence of SBA, the second SBA component 138 may fix a threshold number of the oldest previous states used to determine the new state associated with the machine. The threshold number may include, but is not limited to, the oldest two of five previous states, the oldest three of ten previous states, and/or the like. The second SBA component 138 may then use the constraints, the fixed states, the image data, and/or the motion data 106 to determine the current state of the machine (e.g., the current state of the image sensor(s) 104).

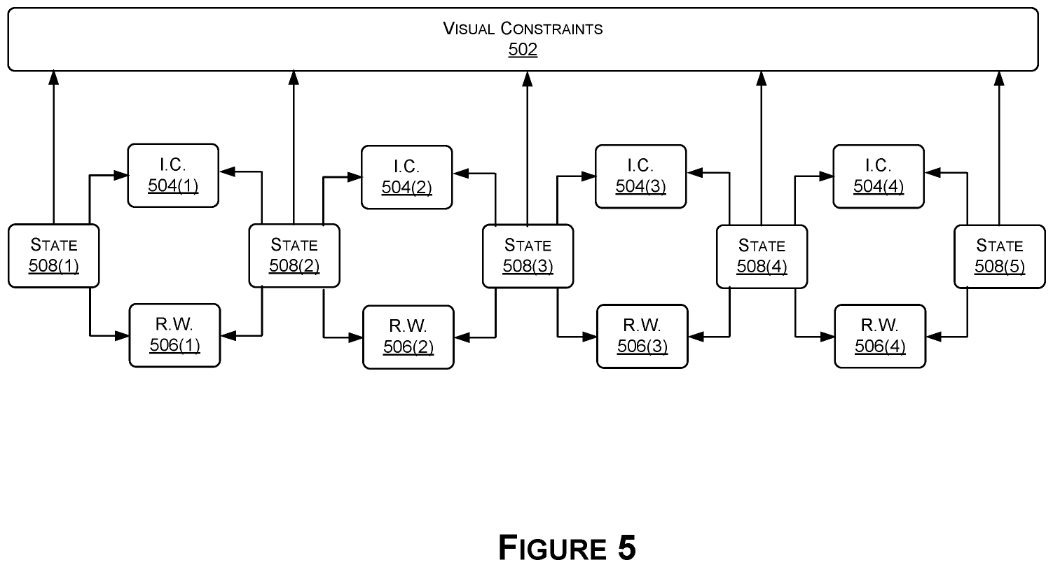

For instance, FIG. 5 illustrates an example of using inertial SBA to determine states associated with a machine, in accordance with some embodiments of the present disclosure. As shown by the example of FIG. 5, the second SBA component 138 may use visual constraints 502, inertial constraints 504(1)-(4), and random walk constraints 506(1)-(4) to determine states 508(1)-(5) associated with the machine. Additionally, in the example of FIG. 5, when determining the current state 508(5) associated with the machine, the second SBA component 138 may fix one or more of the previous states 508(1)-(4). For example, the second SBA component 138 may fix at least the previous state 508(1) and the previous state 508(2) when determining the current state 508(5) associated with the machine.

Referring back to the example of FIG. 1, the second processing component 116 may use an updating component 140 to update the map represented by the map data 114. As described herein, in some examples, the updating component 140 may update the map by updating the locations associated with points within the environment, updating the locations of 3D landmarks within the environment, updating data associated with the states of the machine, and/or so forth. In some examples, the second processing component 116 may then notify the first processing component 110 that the map has been updated.

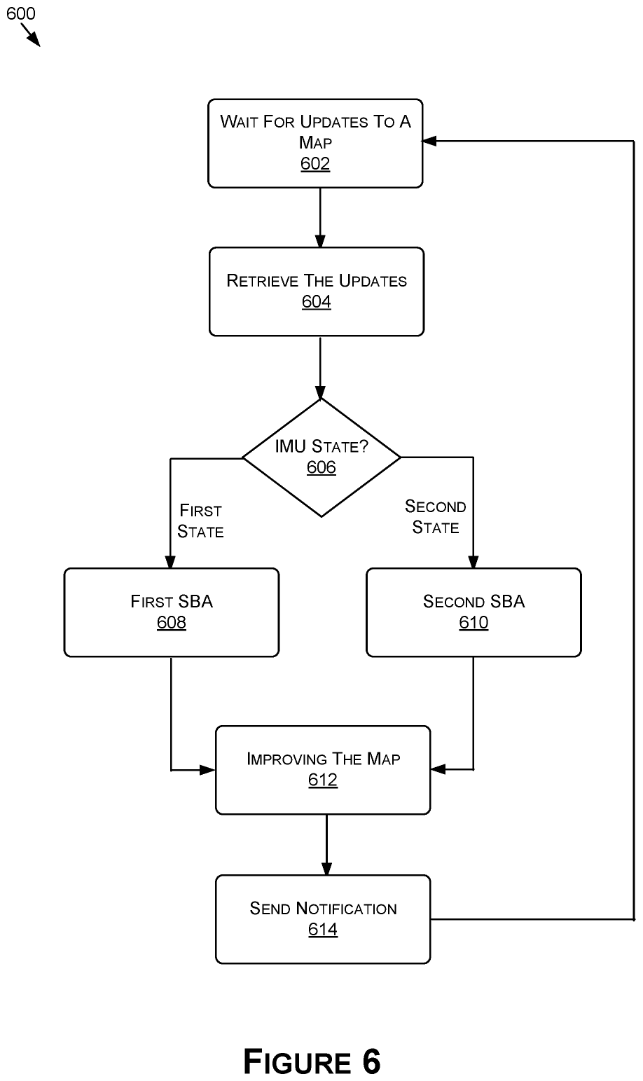

For an example of the processing performed by the second processing component 116, FIG. 6 illustrates an example of a process 600 that may be performed by a SBA thread for determining state information using sensor fusion, in accordance with some embodiments of the present disclosure. As shown, the process 600 may include waiting for updates to a map 602. For example, the second processing component 116 may wait for the first processing component 110 to update the map represented by the map data 128, where the map is associated with tracking the machine within the environment. In some examples, the second processing component 116 may determine that the updates occurred with the map based on receiving a notification from the first processing component 110. Based on determining that the updates occurred, the process 600 may then include retrieving the updates 604 from the first processing component 110.

The process 600 may then include determining an IMU state 606 associated with the IMU sensor(s) (e.g., the motion sensor(s) 108). As described herein, the IMU state may include a first state, such as an uninitialized state or an invalid state, or a second state, such as a valid state, associated with the IMU sensor(s). If it is determined that the IMU state includes the first state, then the process 600 may include processing the image data 402 using a first SBA technique 608. In some examples, the first SBA technique 608 may correspond to the processes described with respect to the first SBA component 136. However, if it is determined that the IMU state includes the second state, then the process 600 may include processing the image data 402 and/or the motion data using a second SBA technique 610. In some examples, the second SBA technique 610 may correspond to the processes described with respect to the second SBA component 138.

The process 600 may then include improving the map 612. For example, the second processing component 116 may use one or more outputs from the first SBA technique 608 and/or the second SBA technique 610 to update the retrieved map (e.g., where the updated map may be represented by the map data 114). In some examples, the second processing component 116 may use one or more of the processes described herein to update the map. The process 600 may then include sending a notification 614 associated with the updates, such as to the first processing component 110. This way, the first processing component 110 determines that the map has been updated by the second processing component 116. The first processing component 110 may then retrieve the updates for the map, such as at 404 of the example process 400 of FIG. 4.

Referring back to the example of FIG. 1, in some examples, such as to run the first PnP technique of the first PnP component 120, the second PnP technique of the second PnP component 122, the first SBA technique of the first SBA component 134, and/or the second SBA technique of the second SBA component 136, the first processing component (e.g., the state component 118) and/or the second processing component 116 (e.g., the state component 134) may need to estimate the direction of a gravity vector with respect to the map represented by the map data 128 and/or the map represented by the map data 114. For example, the state component 118 may need to estimate the gravity vector when performing the gravity vector optimization 212 and/or the gravity vector optimization 224 from the example of FIG. 2.

In some examples, the state component 118 may select a set of states associated with the machine (and/or the image sensor(s) 104) from the map represented by the map data 128. The set of states may include, but is not limited to, one state, two states, five states, ten states, and/or any other number of states. The state component 118 may then estimate the gravity vector direction with respect to the map, estimate the velocity vector with respect to the map, estimate the gyroscope bias associated with the motion sensor(s) 108, and/or estimate the accelerometer bias associated with the motion sensor(s) 108. In some examples, such as to improve one or more of these estimations, the state component 118 may reduce the number of degrees of freedom of the gravity vector optimization.

For instance, the state component 118 may consider a regular Gauss-Newton based optimization task. Additionally, the state component 118 may use a loss function L=L(g) depending on a gravity vector g. The state component 118 may then set g=R_{g}ĝ, where R_{g} is a rotation matrix and ĝ=[0,9.81,0]. In order to run the optimization task, the state component 118 may need to obtain the Jacobian J of the loss function with respect to the optimization variable. For instance, the state component 118 may use the following equation:

$$\\ \begin{matrix}J = \frac{\partial L}{\partial ϕ} = \frac{\partial L}{\partial g} \frac{\partial g}{\partial ϕ} = \frac{\partial L}{\partial g} \frac{{R}_{g} \hat{g}}{\partial ϕ} & ( 15 )\end{matrix}$$

In equation (15), ϕ is a Rodrigues vector corresponding to the rotation matrix R_{g}. As such, the state component 118 may consider the right perturbation derivative model for the gravity direction as the following:

$$\\ \begin{matrix}\frac{\partial {R}_{g} \hat{g}}{δ ϕ} = {lim}_{δ ϕ σ \to 0} \frac{{R}_{g} Exp ( δ ϕ ) \hat{g} - {R}_{g} \hat{g}}{δ ϕ} = {lim}_{δ ϕ \to 0} \frac{{R}_{g} ( I + Skew ( δ ϕ ) ) \hat{g} - {R}_{g} \hat{g}}{δ ϕ} = {lim}_{δ ϕ \to 0} \frac{{R}_{g} Skew ( δ ϕ ) \hat{g}}{δ ϕ} = - {lim}_{δ ϕ \to 0} \frac{{R}_{g} Skew ( \hat{g} ) δ ϕ}{δ ϕ} = - {R}_{g} Skew ( \hat{g} ) & ( 16 )\end{matrix}$$

In some examples, since ĝ is constant, Skew (ĝ) is also constant and represented by the following:

$$\\ \begin{matrix}Skew ( \hat{g} ) = [ \begin{matrix}0 & 0 & - {G}_{norm} \\ 0 & 0 & 0 \\ {G}_{norm} & 0 & 0\end{matrix} ] & ( 17 )\end{matrix}$$

As shown, the middle column of equation (17) is all zeros, which means a redundant degree of freedom in the optimization variable ϕ. As such, the state component 118 may eliminate the corresponding variable and rewrite the matrix as the following:

$$\\ \begin{matrix}Skew ( \hat{g} ) = [ \begin{matrix}0 & - {G}_{norm} \\ 0 & 0 \\ {G}_{norm} & 0\end{matrix} ] & ( 18 )\end{matrix}$$

In some examples, the state component 118 may use a rule of applying updates on the gravity rotation R_{g} on one or more iterations (e.g., each iteration) of the Gauss-Newton optimization by the following:

$$\\ \begin{matrix}{R}_{g}^{{}_{} new} = {R}_{g}^{{}_{} prev} * Exp ( [ {ϕ}_{g} , 0 , {ϕ}_{3} ] ) & ( 18 )\end{matrix}$$

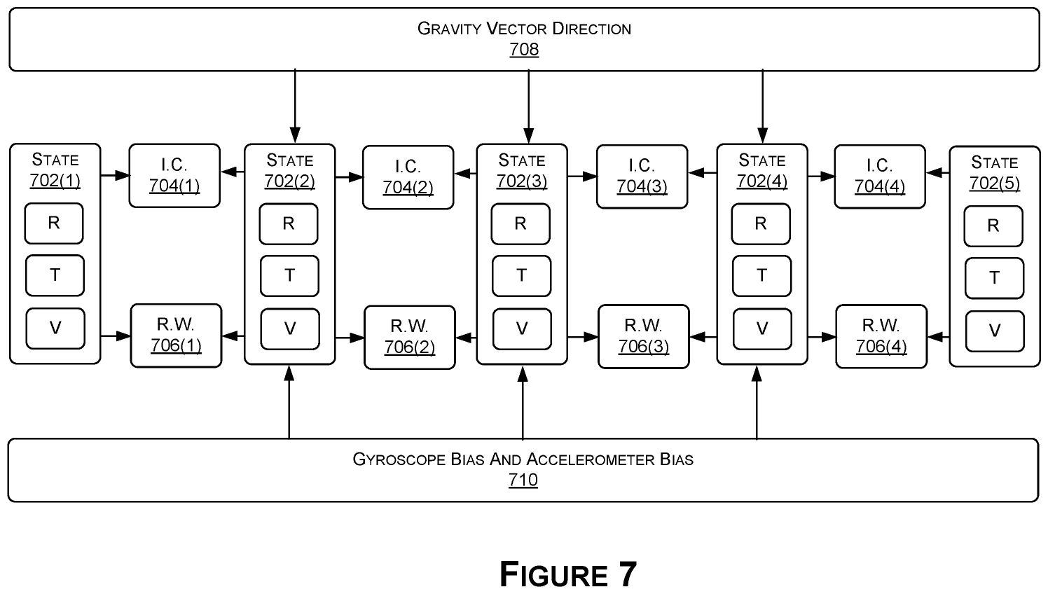

For instance, FIG. 7 illustrates an example of estimating a gravity vector direction, in accordance with some embodiments of the present disclosure. As shown, the state component 118 may use states 702(1)-(5) associated with the machine, which are again determined using inertial constraints 704(1)-(4) and random walk constraints 706(1)-(4), to optimize gravity vector directions 708, gyroscope biases 710, and accelerometer biases 710. For example, the state component 118 may make the determinations using one or more of the equations above. Additionally, when making the determinations, the state component 118 may fix the rotation matrices (e.g., represented by “R”) and the translation vectors (e.g., represented by “T) (which is indicated by the shading in FIG. 7), but cause the velocities (e.g., represented by “V”) from the states 702(1)-(5) to vary.

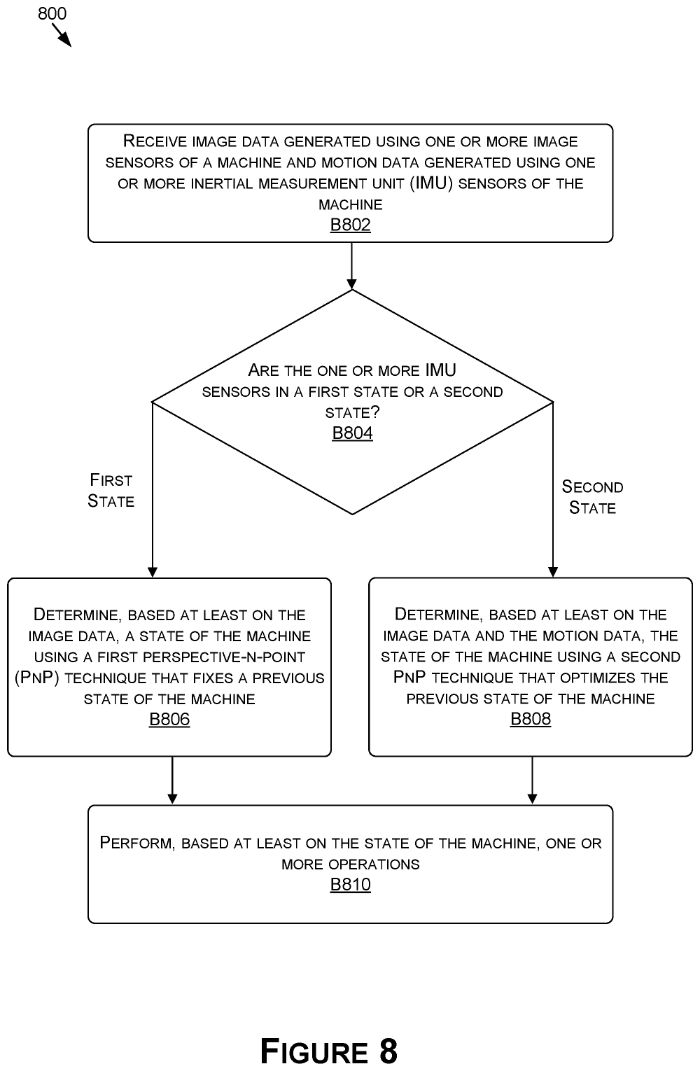

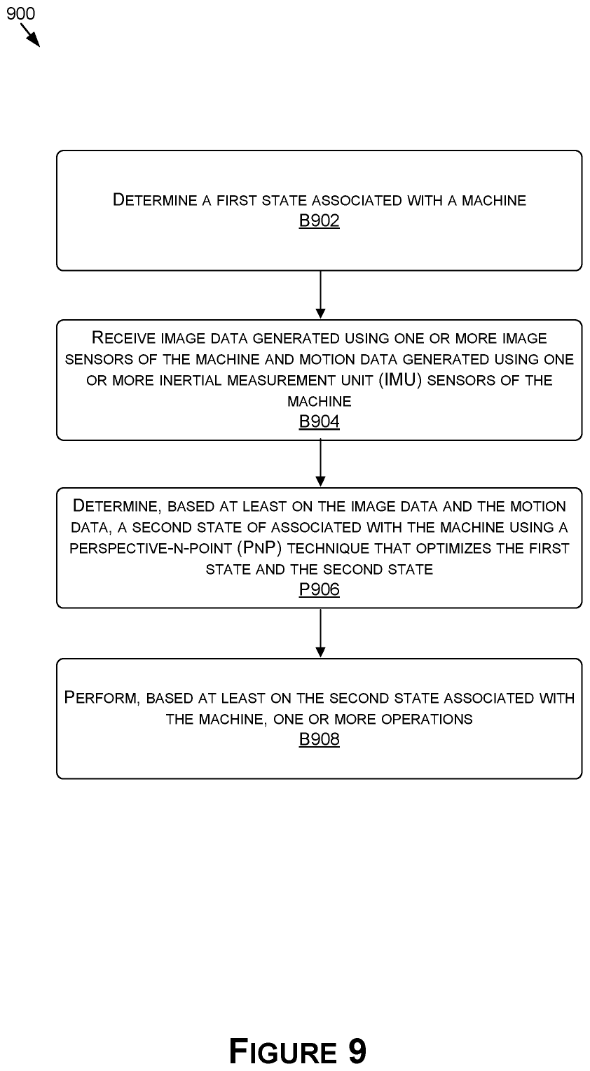

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, the methods 800 and 900 are described, by way of example, with respect to FIG. 1. However, these methods 800 and 900 may additionally or alternatively be executed by any one system, or any combination of systems, including, but not limited to, those described herein.

FIG. 8 is a flow diagram showing a method 800 for determining a state of a machine using different PnP techniques, in accordance with some embodiments of the present disclosure. The method 800, at block B802, may include receiving image data generated using one or more image sensors of a machine and motion data generated using one or more inertial measurement unit (IMU) sensors of the machine. For instance, the machine may generate the image data 102 using the image sensor(s) 104 and the motion data 106 using the motion sensor(s) 108. The first processing component 110, which may include a first thread that is executing in parallel with a second thread associated with the second processing component 116, may then receive the image data 102 and the motion data 106.

The method 800, at block B804, may include determining whether the one or more IMU sensors are in a first state or a second state. For instance, the first processing component 110 (e.g., the state component 118) may determine whether the motion sensor(s) 108 is in the first state or the second state. As described herein, the first state may include an uninitialized state and/or an invalid state and the second state may include a valid state.

If, at block B804, it is determined that the one or more IMU sensors are in the first state, then the process 800, at block B806, may include determining, based at least on the image data, a state of the machine using a first perspective-n-point (PnP) technique that fixes a previous state of the machine. For instance, if the first processing component 110 determines that the motion sensor(s) 108 is in the first state, then the first processing component 110 may determine, based at least on the image data 102 (and/or the motion data 106), the state of the machine using the first PnP component 120. As described herein, the first PnP component 120 determines the state using the first PnP technique that fixes the previous state of the machine. The first PnP technique then uses one or more algorithms that determine the state by optimizing for the state.

However, if, at block B804, it is determined that the one or more IMU sensors are in the second state, then the process 800, at block B808, may include determining, based at least on the image data and the motion data, the state of the machine using a second PnP technique that optimizes the previous state of the machine. For instance, if the first processing component 110 determines that the motion sensor(s) 108 is in the second state, then the first processing component 110 may determine, based at least on the image data 102 and the motion data 106, the state of the machine using the second PnP component 122. As described herein, the second PnP technique determine the state using one or more algorithms that optimize the previous state along with the state.

The method 800, at block B810, may include performing, based at least on the state of the machine, one or more operations. For instance, the first processing component 110 may perform the one or more operations based at least on the state of the machine, such as outputting data representing the state of the machine, updating a track associated with the machine, updating a map, and/or any other operation.

FIG. 9 is a flow diagram showing a method 900 for determining a state of a machine using a PnP technique that optimizes multiple states associated with the machine. The method 900, at block B902, may include determining a first state associated with a machine. For instance, the first processing component 110 (e.g., the first PnP component 120 and/or the second PnP component 122) may determine the first state associated with the machine, where the first state is represented by the state data 112. As described herein, the first state may be associated with one or more first rotation degrees of freedom, one or more first translation degrees of freedom, one or more first velocity degrees of freedom, one or more first gyroscope bias degrees of freedom, one or more first accelerometer bias degrees of freedom, and/or so forth.

The method 900, at block B902, may include receiving image data generated using one or more image sensors of the machine and motion data generated using one or more inertial measurement unit (IMU) sensors of the machine. For instance, the machine may generate the image data 102 using the image sensor(s) 104 and the motion data 106 using the motion sensor(s) 108. The first processing component 110, which may include a first thread that is executing in parallel with a second thread associated with the second processing component 116, may then receive the image data 102 and the motion data 106.

The method 900, at block B906, may include determining, based at least on the image data and the motion data, a second state associated with the machine using a perspective-n-point (PnP) technique that optimizes the first state and the second state. For instance, the first processing component 110 may determine the second state using the second PnP component 122.

As described herein, the second PnP component 122 may determine the second state using the second PnP technique that optimizes both the first state and the second state. For instance, in some examples, the second PnP technique may generate a first random variable associated with the first state and a second random variable associated with the second state. The second PnP technique may then optimize the first random variable and the second random variable to determine the second state. As described herein, the second state may be associated with one or more second rotation degrees of freedom, one or more second translation degrees of freedom, one or more second velocity degrees of freedom, one or more second gyroscope bias degrees of freedom, one or more second accelerometer bias degrees of freedom, and/or so forth.

The method 900, at block B908, may include performing, based at least on the second state associated with the machine, one or more operations. For instance, the first processing component 110 may perform the one or more operations based at least on the second state associated with the machine, such as outputting data representing the second state associated with the machine, updating a track associated with the machine, updating a map, and/or any other operation.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices.

The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060m (front) or 80m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5m, 4m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the 12V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084 (H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof. Although the various blocks of FIG. 11 are shown as connected via the interconnect

system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161 (N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining whether one or more inertial measurement unit (IMU) sensors of a machine are operating in a first state or a second state;
when the one or more IMU sensors are operating in the first state, determining, using a first perspective-n-point (PNP) technique and based at least on image data generated using one or more image sensors of the machine and motion data generated using the one or more IMU sensors of the machine, a state of the machine;
when the one or more IMU sensors are operating in the second state, determining, using a second PNP technique and based at least on the motion data and the image data, the state of the machine; and
performing, based at least on the state of the machine, one or more operations.

2. The method of claim 1, wherein:
the state of the machine is associated with a first time;
the method further comprises determining a second state of the machine, the second state being associated with a second time that is before the first time; and
the first PnP technique determines the state of the machine based at least on the image data, the motion data, and fixing the second state of the machine.

3. The method of claim 1, wherein:
the state of the machine is associated with a first time;
the method further comprises determining a second state of the machine, the second state being associated with a second time that is before the first time; and
the second PnP technique determines the state of the machine based at least on the image data, the motion data, and a randomized value of a variable that is based at least on the second state of the machine.

4. The method of claim 3, wherein the determining the state of the machine using the second PnP technique comprises:
generating the randomized value of the variable associated with the second state;
generating a second randomized value of the variable associated with the state;
optimizing, using one or more algorithms and based at least on the image data, the motion data, the first randomized value and the second randomized value, the variable; and
determining the state of the machine based at least on the variable as optimized.

5. The method of claim 1, wherein the determining whether the one or more IMU sensors of the machine are operating in the first state or the second state comprises:
determining a number of failures associated with determining one or more previous states of the machine; and
determining, based at least on the number of failures, whether the one or more IMU sensors of the machine are operating in the first state or the second state.

6. The method of claim 5, wherein the determining whether the one or more IMU sensors of the machine are operating in the first state or the second state comprises:
determining that the machine is operating in the first state based at least on the number of failures being equal to or greater than a threshold number of failures; or
determining that the machine is operating in the second state based at least on the number of failures being less than the threshold number of failures.

7. The method of claim 1, wherein the determining whether the one or more IMU sensors are operating in the first state or the second state occurs at a first time and is based at least on state data associated with the one or more IMU sensors, and wherein the method further comprises:
determining, based at least on the determining of the state of the machine, an error using at least one of one or more inertial constraints, one or more random walk constraints, or one or more visual constraints;
determining, at a second time and based at least on the error, whether the one or more IMU sensors are operating in the first state or the second state; and
updating the state data based at least on the determining whether the one or more IMU sensors are operating in the first state or the second state at the second time.

8. The method of claim 1, further comprising:
determining an error associated with the determining the state of the machine; and
performing at least one of:
updating a track associated with the machine to include the state when the error is less than a threshold error; or
terminating the track associated with the machine when the error is equal to or greater than the threshold error.

9. The method of claim 1, further comprising:
retrieving a map generated using one or more sparse bundle adjustment (SBA) techniques,
wherein the determining the state of the machine is further based at least on the map.

10. The method of claim 9, further comprising performing one of:
based at least on the one or more IMU sensors operating in the first state, updating, based at least on the motion data, the map using a first SBA technique; or
based at least on the one or more IMU sensors operating in the second state, updating, based at least on the motion data and the image data, the map using a second SBA technique.

11. The method of claim 1, wherein the performing the one or more operations comprises one or more of:
storing at least one of the image data or data representing the state of the machine in association with a map; or
causing, based at least on the state of the machine, the machine to navigate along one or more paths.

12. The method of claim 1, wherein the state of the machine includes at least one of:
one or more values associated with a rotation of the machine;
one or more values associated with a translation of the machine;
one or more values associated with a velocity of the machine;
one or more values associated with a gyroscope bias associated with the one or more IMU sensors; or
one or more values associated with an accelerometer bias associated with the one or more IMU sensors.

13. A system comprising:
one or more processing units to:
determine a first state associated with a machine;
receive image data generated using one or more image sensors of the machine and motion data generated using one or more inertial measurement unit (IMU) sensors of the machine;
determine, using one or more perspective-n-point (PNP) techniques that optimize the first state and a second state of the machine based at least on the image data and the motion data, the second state of the machine; and
perform, based at least on the second state of the machine, one or more operations.

14. The system of claim 13, wherein the determination of the second state of the machine comprises:
associating the first state of the machine with a first random variable and the second state of the machine with a second random variable;
determine, using the one or more PNP techniques and based at least on the image data and the motion data, a first optimization associated with the first random variable and a second optimization associated with the second random variable; and
determining, based at least on the second random variable, the second state of the machine.

15. The system of claim 14, wherein:
the first random variable comprises a first matrix that represents one or more first degrees of freedom associated with the first state of the machine; and
the second random variable comprises a second matrix that represents one or more second degrees of freedom associated with the second state of the machine.

16. The system of claim 13, wherein the one or more processing units are further to:
determine one or more constraints that limit one or more values associated with the first state to be within one or more ranges,
wherein the determination of the second state of the machine is further based at least on the one or more constraints.

17. The system of claim 13, wherein the one or more processing units are further to:
receive second image data generated using the one or more image sensors of the machine and second motion data generated using the one or more IMU sensors of the machine; and
determine, using the one or more PnP techniques that optimize the second state and a third state of the machine based at least on the second image data and the second motion data, the third state of the machine.

18. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implementing one or more large language models (LLMs);
a system implemented using an edge device;
a system implemented using a machine;
a system for performing conversational AI operations;
a system for generating synthetic data;
a system incorporating one or more virtual machines (VMs);
a system implemented at least partially in a data center; or
a system implemented at least partially using cloud computing resources.

19. A processor comprising:
one or more processing units to determine a state of a machine using one or more perspective-n-point (PNP) techniques and based at least on a previous state of the machine, wherein the one or more PNP techniques determine the state of the machine by optimizing the previous state of the machine and the state of the machine based at least on image data generated using one or more image sensors of the machine and motion data generated using one or more inertial measurement unit (IMU) sensors of the machine.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implementing one or more large language models (LLMs);
a system implemented using an edge device;
a system implemented using a machine;
a system for performing conversational AI operations;
a system for generating synthetic data;
a system incorporating one or more virtual machines (VMs);
a system implemented at least partially in a data center; or
a system implemented at least partially using cloud computing resources.
